(19) United States
(12) Patent Application Publication
(10) Pub. No.: US 2019/0123894 A1
(43) Pub. Date: Apr. 25, 2019

(54) PROGRAMMABLE HARDWARE BASED DATA ENCRYPTION AND DECRYPTION SYSTEMS AND METHODS

(71) Applicant: Zhichao Yuan, San Jose, CA (US)

(72) Inventor: Zhichao Yuan, San Jose, CA (US)

(21) Appl. No.: 16/168,544

(22) Filed: Oct. 23, 2018

Related U.S. Application Data
(60) Provisional application No. 62/575,939, filed on Oct. 23, 2017.

(51) Int. Cl. H04L 9/08; G06F 9/48; H04L 12/851

(52) U.S. Cl. CPC H04L 9/0819; H04L 47/24; G06F 9/4881

(57) ABSTRACT

Aspects of the present disclosure are presented for a network data processing system (a network server, a datacenter or even a chain of cloud based services) that includes a traditional microprocessor based main data processing unit and programmable hardware based data processing unit. The programmable hardware based data processing unit is configured to conduct encryption and decryption of data before delivering the processed data to the main data processing unit. In this way, resources of the main data processing unit are saved and made more efficient to allow the main data processing unit to perform other core business or commercial tasks.

### CROSS REFERENCE TO RELATED APPLICATION

This application claims the benefit of U.S. Provisional Application 62/575,939, filed Oct. 23, 2017, and titled “PROGRAMMABLE HARDWARE BASED DATA ENCRYPTION AND DECRYPTION SYSTEMS AND METHODS,” the disclosure of which is hereby incorporated herein in its entirety and for all purposes.

### TECHNICAL FIELD

The subject matter disclosed herein relates to hardware based network data encryption and processing, and, more specifically to producing hardware accelerated network data encryption and processing methods with multi-thread, priority based mechanisms embedded.

### BACKGROUND

It is important for businesses to be concerned about the security of their networks. The number, variety and strength of the threats to network security have greatly increased over the years, especially with business confidential data and information being migrated onto cloud. Businesses need to be prepared against an ever-changing landscape of network attacks and take approaches to deal with data security issues.

Data encryption along with proper key management can provide a safe harbor to prevent information breach or data from being stolen. It has become a must-have element in any security strategy for its ability to slow down and even deter hackers from stealing sensitive information. There are a number of industry-tested and accepted standards and algorithms for encryption to cope with different level of security needs, including industry standard AES (Advanced Encryption Standard, 128 bits and higher), SM4 (Chinese National Standard, 128 bits), TDES (minimum double-length keys), RSA (2048 bits and higher), ECC (160 bits and higher), and El Gamal (1024 bits and higher) (See NIST Special Publication 800-57 for more information).

While generally the case that the more complicated the encryption algorithm, the more secure or less likely it can be deciphered by hackers, this also tends to mean the complicated encryption algorithm consumes a large amount of a business' own network computing resources for data encryption and decryption. This generally slows down core business. There are also reliability issues when relying on a cloud computing system to handle encryption/decryption requests. In general, it is desirable to conduct encryption and decryption in a faster and more reliable way to address the growing needs of today's computer technology.

### BRIEF SUMMARY

Aspects of the present disclosure are presented for optimized data encryption and decryption methods on the network application layer using programmable hardware, such as a field-programmable gate array (FPGA), digital signal processor (DSP) or graphical processing unit (GPU), etc. Key network parameters such as network latency, quality of service (QoS) and network energy efficiency are considered in some embodiments.

In some embodiments, a network data processing system (a network server, a datacenter or even a chain of cloud based services) includes a traditional microprocessor based (CPU in most of the scenarios) main data processing unit and programmable hardware based data processing unit.

In some embodiments, a system comprising a main processing unit for processing data in incoming data packets; and a programmable, hardware parallel-processing unit in communication with the main processing unit via a host communication interface is presented. The programmable, hardware parallel-processing unit may be configured to: receive the incoming data packets, wherein the incoming data packets are encrypted; analyze a packet header for each of the incoming data packets; prioritize the incoming data packets based on information in the analyzed packet header for each incoming data packet; place the received, incoming data packets in a decryption queue for decryption based on the prioritization; decrypt the received, incoming data packets in the order of placement in the queue for decryption; and place the decrypted data packets in a data queue for processing by the main processing unit, based on the prioritization. The higher priority decrypted data packets are put in a front of the data queue and lower priority decrypted data packets are put in back of the data queue. The main processing unit retrieves and processes the decrypted data packets from the data queue, wherein the main processing unit processes the decrypted data packets from the front of the data queue before processing the decrypted data packets from the back of the data queue.

In some embodiments of the system, the prioritization of the decrypted data packets is based on pre-set priority rules.

In some embodiments of the system, the main processing unit includes a central processing unit, and the programmable, hardware parallel-processing unit comprises at least one of a field programmable gate array (FPGA), digital signal processor (DSP), and a graphical processor unit (GPU).

In some embodiments of the system, the main processing unit further comprises a security engine configured to provide decryption keys to the programmable, hardware parallel-processing unit for decrypting the incoming data packets.

In some embodiments of the system, the programmable, hardware parallel-processing unit includes a packet scheduler, an encryption/decryption engine, and a data packet filter.

In some embodiments of the system, the programmable, hardware parallel-processing unit comprises a plurality of encryption/decryption engines spaced evenly across a hardware die such that the hardware die heats evenly across its entirety after the plurality of encryption/decryption engines are activated. In some embodiments of the system, the programmable, hardware parallel-processing unit comprises an encryption/decryption scheduler configured to activate each of the plurality of encryption/decryption engines only as needed to perform encryption/decryption of the incoming data packets. In some embodiments of the system, the encryption/decryption scheduler is further configured to select which of the encryption/decryption engines is to be activated based on locations of existing activated encryption/decryption engines, such that a next activated encryption/decryption engine is activated in a location that minimizes an imbalance of heat generation across the hardware die.

In some embodiments of the system, the programmable, hardware parallel-processing unit is further configured to: analyze the decrypted data packets; and re-prioritize the data packets based on the analyzed decrypted data packets; wherein the placing of the decrypted data packets in the data queue for processing by the main processing unit is based on the re-prioritization.

In some embodiments of the system, the data packet filter is configured to de-prioritize or drop an incoming data packet after determining that the incoming data packet originates from a suspicious source.

In some embodiments of the system, the programmable, hardware parallel-processing unit is further configured to decrypt data packets in parallel.

In some embodiments, a method of a programmable, hardware parallel-processing unit for encrypting and decrypting data packets is presented. The hardware parallel-processing unit may be in communication with a main processing unit via a host communication interface. The method may include: receiving incoming data packets, wherein the incoming data packets are encrypted; analyzing a packet header for each of the incoming data packets; prioritizing the incoming data packets based on information in the analyzed packet header for each incoming data packet; placing the received, incoming data packets in a decryption queue for decryption based on the prioritization; decrypting the received, incoming data packets in the order of placement in the queue for decryption; and placing the decrypted data packets in a data queue for processing by the main processing unit, based on the prioritization. Higher priority decrypted data packets are put in a front of the data queue and lower priority decrypted data packets are put in back of the data queue. The main processing unit retrieves and processes the decrypted data packets from the data queue, wherein the main processing unit processes the decrypted data packets from the front of the data queue before processing the decrypted data packets from the back of the data queue.

In some embodiments, a system comprising a main processing unit for processing data in outgoing data packets; and a programmable, hardware parallel-processing unit in communication with the main processing unit via a host communication interface is presented. The programmable, hardware parallel-processing unit is configured to: receive the outgoing data packets from the main processing unit, wherein the outgoing data packets are decrypted; analyze the outgoing data packets; prioritize the outgoing data packets based on information in the outgoing data packets; place the received, outgoing data packets in an encryption queue for encryption based on the prioritization; encrypt the received, outgoing data packets in the order of placement in the queue for encryption; and transmit the encrypted data packets according to the order encrypted through an egress interface. Higher priority outgoing data packets are put in a front of the data queue and lower priority outgoing data packets are put in back of the data queue. The programmable, hardware parallel-processing unit retrieves and processes the decrypted data packets from the data queue, wherein the programmable, hardware parallel-processing unit encrypts the decrypted data packets from the front of the data queue before encrypting the decrypted data packets from the back of the data queue.

### BRIEF DESCRIPTION OF THE DRAWINGS

Some embodiments are illustrated by way of example and not limitation in the figures of the accompanying drawings.

FIG. 1 is a block diagram of a data processing system with a main processing unit and a hardware data processing unit, in accordance with some embodiments.

FIG. 2 is a flow diagram illustrating how the ingress data packets are filtered, prioritized and processed in the data processing system illustrated in FIG. 1, according to some embodiments.

FIG. 3 is a flow diagram illustrating how the egress data packets are processed in the data processing system illustrated in FIG. 1, according to some embodiments.

FIG. 4 is a block diagram of a encryption/decryption engine in accordance with some embodiments, which resides in the hardware data processing unit illustrated in FIG. 1.

FIG. 5 is an example distribution of encryption/decryption engines on a hardware die, including some activated engines made in a particular order, according to some embodiments.

### DETAILED DESCRIPTION

Aspects of the present disclosure are presented for optimized data encryption and decryption methods on the network application layer using programmable hardware. With the growing need to provide secure communications across data communication lines that may span across the globe, traditional means for providing encryption and decryption that rely on network computing resources may be insufficient. Core business needs that rely on traditional network computing resources may be slowed and/or may be performed less reliably.

As an example, the highly regulated area such as the financial industry demands a high standard data encryption on sensitive data as required by GLBA (Gramm-Leach-Bliley Act, also known as the Financial Modernization Act of 1999) and FFIEC (Federal Financial Institutions Examination Council) that will consume bank datacenters or servers if computing resources are diverted for data encryption/decryption. This can increase network latency and cause delay of customer service, etc.

Regarding reliability, typically, the standard server or cloud computing system is a server-client based system with applications running services that handle many kinds of requests from network clients. The system is highly vulnerable when there is a flood of requests from network clients either during busy business occasions, such as Black Friday when there are large number of business transactions needs to be handled by bank server systems, or from malicious attacks such as a distributed denial of service (DDoS) attack. The system is liable to generate errors when handling all the packets in the system network queue buffer with frequent encryption/decryption processes. As a result, the system starts to randomly drop out session-based data packets or set timeouts randomly. This random data packet drop or timeout will not only cause a current active session to fail, but also will trigger another round of requests from the same client and produce even worse network traffic. A system crash can result, and in the worst case the whole server system will be out of service due to the request flood.

In contrast, conducting data encryption and decryption on programmable logic devices or hardware such as FPGAs, DSPs or GPUs instead of directly on data center servers with traditional soft core microprocessors (e.g. central processing unit, or CPU), can mitigate these concerns. Encryption and decryption tasks can be processed by the above mentioned programmable hardware in parallel by multiple sub logic modules, while microprocessors such as a CPU can only process the task sequentially. A datacenter or cloud service system equipped with a hardware processing unit can offload labor intensive but less logical work from a CPU to shorten the overall process time, increase the overall network efficiency and improve customer satisfaction. In addition, it can also further enhance the network security be performing data pre-processing and filtering which will block the large portion of illegal or suspicious data from congesting or even damaging the whole network.

Despite the above-mentioned features of an encryption/decryption system using integrated programmable logic, there is no widely adopted hardware based data encryption/decryption and pre-processing system in the commercial market. Areas such as energy efficiency and QoS are overlooked in the existing designs, which however, are essential to be commercially successful.

The present disclosure addresses at least these issues, and introduced herein are optimized data encryption and decryption methods on the network application layer using programmable hardware such as FPGA, DSP or GPU, etc. Key network parameters such as network latency, QoS and network energy efficiency are considered in some embodiments.

According to some embodiments, a network data processing system (a network server, a datacenter or even a chain of cloud based services) is presented that includes a traditional microprocessor based (CPU in most of the scenarios) main data processing unit and programmable hardware based data processing unit (referred as “hardware processing unit”).

In some embodiments, network ingress data packets coming from the Internet or other service chain are pre-processed in a data packet filter module residing inside the hardware data processing unit. Data packets are filtered and sorted with pre-defined priority in the data packet filter module by an in-depth detection algorithm embedded. The prioritized data packets are categorized after pre-processing through a Data Packet Filter. Encrypted data packets are selected by the data packet filter and sent to data encryption/decryption engine for decryption. Encryption tasks can be scheduled and prioritized by the encryption/decryption scheduler inside the encryption/decryption engine. Multiple encryption/decryption tasks can be executed in parallel by encryption/decryption modules inside the encryption/decryption engine. Once a decryption process is complete, decrypted data packets will then be sent to a packet scheduler in the hardware processing unit for further prioritization and queuing, where content of each decrypted data packet can be read by a packet scheduler to tell the type of service request that is included in the data packet. Higher prioritized decrypted data packets such as bank transaction sessions will be sent to the main processing unit for processing first, according to some embodiments. Data sessions such as bank webpage browsing requests will be lower prioritized and put to the back of the queue going into the main processing unit. Decrypted data packets are processed by software applications in the main data process unit with service requests being handled. Result data packets are then sent back to the hardware data processing unit for encryption, if needed, before they are sent back to the Internet or cloud chain services.

In some embodiments, data inflow always comes to the hardware data processing units to be filtered and pre-processed before sending to the main processing unit for further request handling. When it comes to data outflow, the date is transmitted to the hardware data processing unit to get necessary data packets encryption before sending it back to the Internet or cloud service chains.

The above described mechanisms will bring significant efficiency improvement to the server/data center system by offloading resources consuming the encryption/decryption workload from the main processing unit, by filtering and prioritizing data to reduce and optimize the data entering main processing unit, as well as by avoiding data sending back and forth between the main data processing unit and the hardware process unit like exiting hardware encryption/decryption technology does.

In some embodiments, encryption/decryption engine within the hardware data process unit is virtualized to form an encryption/decryption engine pool comprising a number of parallel virtual encryption/decryption processing modules, which can be coordinated through the encryption/decryption scheduler to process multiple encryption and decryption tasks simultaneously.

It is to be understood that embodiments described herein and in detailed description are not intended to limit the scope of the claimed invention, but rather these embodiments are intended only to provide a brief summary and detailed description of possible forms of the invention. As a matter of fact, the invention may encompass a variety of forms that may be similar to or different from the embodiments set forth. Similarly, when introducing elements of various embodiments of the present invention, the articles “a,” “an,” and “the” etc. are intended to mean that there are one or more of the elements. The terms “comprising,” “including,” etc. are intended to be inclusive and mean that there may be additional elements other than the listed elements. As used herein, the conjunction “or” refers to a non-exclusive “or,” unless specifically stated otherwise.

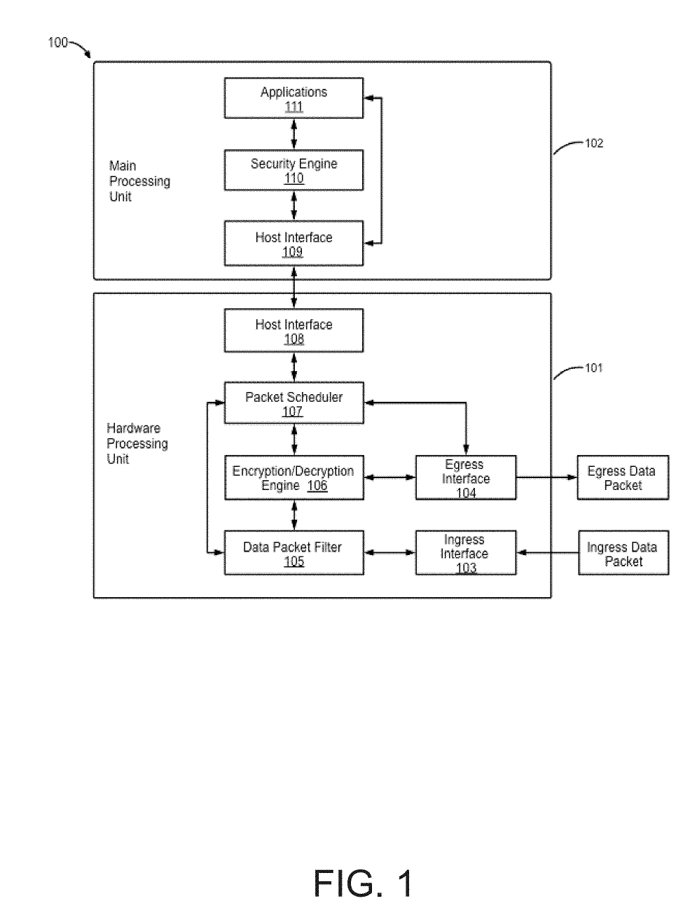

FIG. 1 illustrates an example data processing system 100 with a main processing unit 102 and a hardware processing unit 101 working together, according to some embodiments.

In some embodiments, hardware processing unit 101 is an FPGA based data processing unit. In some embodiments, hardware processing unit 101 is a DSP based data processing unit. In other cases, hardware processing unit 101 is a GPU based data processing unit. In general, the hardware processing unit 101 may include one or more processing units based in hardware that are capable of ingesting data and performing functions on the data, such as decryption and encryption functionality.

In some embodiments, hardware processing unit 101 connects with main processing unit 102 via software host interface 108 and host interface 109. An example of the host interface 108 is a PCIe device that may be used on the hardware side when connecting to a host, and an example of the host interface 109 is a PCIe driver on the host side. When the whole data processing system is booted, the main processing unit 102 will load the drivers (e.g., files that enable hardware processing unit 101 to communicate with main processing unit 102).

In some embodiments, hardware data process unit 101 may be an independent hardware device connected to main data process unit 102 via standard physical interfaces such as PCIE. Multiple hardware data processing units same as copies or duplicates of hardware processing unit 101 may be connected to the main process unit 102 in order to increase the hardware processing capability. These multiple hardware processing units may be configured to operate in parallel with one another. In this case, communication will be established between host interface 109 inside main processing unit 102 and host interfaces 108 in each individual hardware processing unit 101.

In some embodiments, an ingress interface 103 inside hardware processing unit 101 may connect with and receive data packets from outside the data processing system 100. In other embodiments, there may be multiple ingress interfaces similar to ingress interface 103.

In some embodiments, an egress interface 104 inside hardware processing unit 101 may connect and send processed data packets to outside of the data processing system 100. In other embodiments, there may be multiple egress interfaces similar to egress interface 104.

In some embodiments as illustrated in FIG. 1, hardware processing unit 101 includes a data packet filter 105 with data sorting and prioritization capabilities. In some embodiments, the data packet filter 105 may be a programmable deep packet investigating classifier, which may be configured to classify packets based on information in OSI layers L2-L7. Data packet filter 105 connects to and receives data packets from ingress interface 103 for pre-processing. It also connects and sends encrypted data packets to encryption/decryption engine 106. In some embodiments, data packet filter 105 also directly connects and communicates with packet scheduler 107. In some embodiments the packet scheduler 107 is a QoE (Quality of Experience) based multi-queue grinder. In some embodiments, the priority of each packet determined by the packet scheduler 107 is not based on the L2-L4 levels (i.e., the data link, network, or transport layers) of an IP/TCP packet, but based on the L7 (Application layer) information. The packet scheduler may try to determine that how important the packet is towards the application itself, and under this network environment, packet priority shall support the best end user experience. The packet scheduler may be configured to examine or analyze some aspects of the origins of the data packet, the header information, or at least some of the content of the packet to determine how relevant it is at the application layer.

In some embodiments, an encryption/decryption engine 106 inside hardware processing unit 101 may connect and communicate with data packet filter 105 and packet scheduler 107. As alluded to above, the encryption/decryption engine 106 may be a hardware based program that allows for the encryption/decryption to be performed faster than via a pure software solution. It may also connect and send data packets to egress interface 104.

In some embodiments, encryption/decryption engine 106 may be capable of data packet encryption and decryption. During the encryption process, it may prioritize encrypted data packets based on session ID information in an encrypted data packet's head file.

In some embodiments, encryption/decryption engine 106 may be configured to update its algorithms to cope with encryption and decryption tasks with different standards such as AES, SM4, Blowfish and RSA, etc.

In some embodiments, hardware processing unit 101 may include a packet scheduler 107, which may connect and communicate with both encryption/decryption engine 106 and host interface 108. It may also directly connect and communicate with egress interface 104 and data packet filter 105.

In some embodiments, packet scheduler 107 may prioritize and sort all data packets sent into the data processing system 100, so as to optimize system efficiency. For example, the packet scheduler 107 may analyze certain metadata and/or packet content and prioritize the packets utilizing pre-determined prioritizations based on what is seen.

In some embodiments, main processing unit 102 is part of a typical business server system, illustrating that the systems described herein may be effectively embedded into readily available commercial technology. For example, main processing unit 102 may be part of a typical enterprise or commercial data center network. In some cases, main process unit 102 is part of a typical cloud chain service.

In some embodiments, main processing unit 102 includes multiple software applications 111 that process data packets with various client requests.

In some embodiments, main processing unit 102 may include a software based security engine 110 that may include a software library and/or processes that handle the security layer service requests and provide reliable, safe, and application QoS optimized interfaces for applications 111. The security engine 110 may be implemented like a SSL/TLS stack, for example.

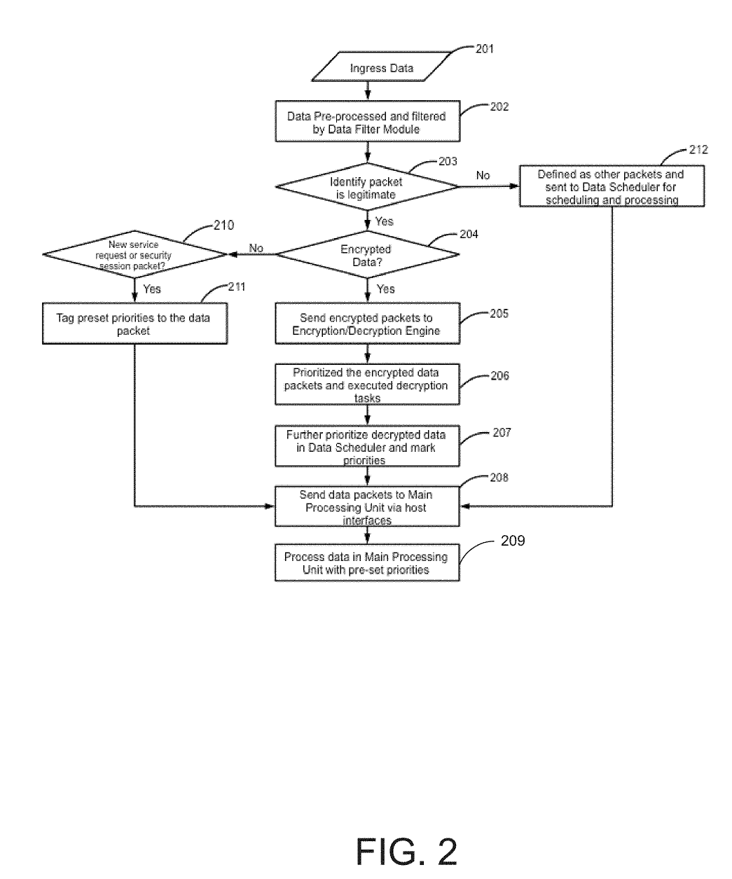

FIG. 2 illustrates an example process of how ingress data packets are filtered, prioritized and processed in the data processing system illustrated in FIG. 1, according to some embodiments. The example process flow illustrates how data packets may be ingested, decrypted and/or encrypted by a programmable hardware unit, thereby reducing processing demands on the main processing unit 102.

At block 201, data packets coming into the data processing system 100 first arrive at ingress interface 103, which passes data packets to data packet filter 105. Data packets are pre-processed based on head file information coming together with each data packet (Block 202). Rules may be defined to judge if the data package is “legitimate” or “legal.” For example, at block 203, the data packet filter 105 may ingest a data packet that may be illegitimate or illegal if the data packet received has a wrong destination IP address by mistake or a random remote ping from a network client. Thus, at block 212, such data packets will be tagged as “illegitimate” or “illegal,” and may be given lowest priority and sent directly to packet filter 107 for further processing and prioritization.

In some embodiments, data packet filter 105 may drop data packets coming from certain IP addresses or set packet rate limits to lower the packet incoming rate. This process may be done in coordination with packet scheduler 107 within hardware processing unit 101 without main processing unit 102 involvements.

Once the packet is identified as legitimate, at block 204 the engine determines whether the packet is encrypted or contains encrypted data. At block 205, the “legitimate” encrypted data packets will then be sent to encryption/decryption engine 106 for decryption process. Referring to blocks 210 and 211, unencrypted data packets will be further sorted by data filter 105 before being sent directly to main processing unit 102 via host interface 108 and 109 with new service request data packets and security session packets being prioritized based on pre-set rules.

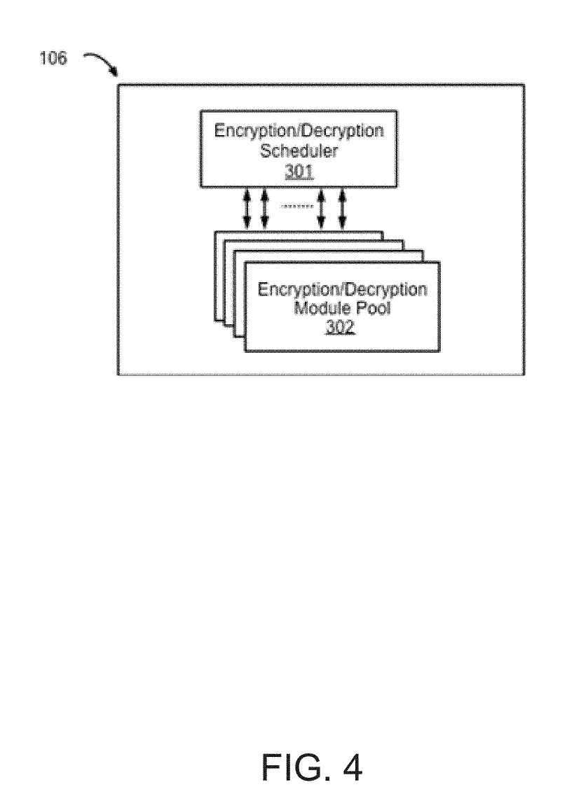

At block 206, following block 205, encrypted data packets are decrypted by encryption/decryption engine 106. FIG. 4 is a block diagram illustrating how encryption/decryption engine 106 works.

In some embodiments, an encryption/decryption scheduler 301 (see FIG. 4) inside encryption/decryption engine 106 prioritizes and overall coordinates the encryption decryption tasks by enabling one or multiple encryption/decryption processing modules in encryption/decryption module pool 302 based on the size of the data packets that need to be encrypted or decrypted.

As illustrated by FIG. 4, encrypted ingress data packets entering the encryption/decryption engine 106 will first look for User IP address and session ID from the packet head file in order to decide processing privilege. Each data packet will be tagged with a priority grade and added to the specific priority queue. This priority grade may be based on a reference to pre-determined prioritizations, such as those found in a lookup table, for example. Data packets with higher priorities will be scheduled ahead of ones with lower priorities. During execution, encryption/decryption scheduler will assign one or multiple encryption/decryption modules 302 to the target data packets.

In some embodiments, the key for decryption will be generated and provided by security engine 110 and delivered to encryption/decryption engine 106 via host interface 109 and 108. During the decryption process the key is managed both within the main processing unit 102 and hardware processing unit 101 without being sent to outside of data processing system 100. For example, in some embodiments the main processing unit 102 may be configured to handle the logic of key initialization and exchanging with a remote connection for a first key by executing a standard process (e.g., defined by SSL/TLS). The key may then be downloaded to the hardware processing unit 102 for packet processing.

In some embodiments, multiple encryption and decryption tasks may be executed simultaneously, as is possible with a hardware solution capable of performing parallel encryption/decryption tasks simultaneously. The size of an encryption/decryption module group may also be dynamically adjusted by encryption/decryption scheduler 301.

In some embodiments, a part or the entire encryption/decryption module pool 302 may be configured to update its algorithms to execute encryption and decryption tasks with different standards (such as AES, SM4, Blowfish and RSA, etc.) or even other tasks such as data mining.

In some embodiments, the encryption/decryption scheduler 301 may consider power balance of the encryption/decryption engine 106. For example, it may span the working encryption/decryption modules inside the encryption/decryption module pool 302 physically across the whole hardware chip to avoid local overheating. In some embodiments, the resource pool of the hardware processing unit is virtualized so that there will not be concentrated areas on the chip or other hardware that gets overheated more so than other areas when running heavy encryption/decryption tasks. Idle modules that are not used during encryption/decryption of a particular task will be set to sleep so as to maximize efficiency and reduce energy consumption. Other modules will be set to sleep after a given task is complete and are not used during the next encryption/decryption process.

In some embodiments, the encryption/decryption scheduler 301 may be configured to perform power balancing of the hardware processing unit 101 in two ways. First, the scheduler 301 may dynamically determine from where the resources are being used so as to prevent overheating of the hardware resources. Second, the scheduler 301 may dynamically determine how many resources to allocate to each encryption/decryption process.

Regarding the first way involving preventing overheating of the hardware, the scheduler may be configured to draw resources among the die evenly based on the physical location. As an example, in an implementation utilizing an FPGA, suppose the FPGA die size is 400 mm², 20 mm×20 mm square. Suppose 100 encryption/decryption engines may be initialized in it, along with other processes. In this example, the scheduler may arrange the engines in a 10×10 pattern in a die of the FPGA to evenly distribute the resources. The scheduler may utilize all of the space, such that one engine is on each 2 mm×2 mm square of the FPGA die, instead of put all 100 engines together on the top 200 mm2, for example. If concentrated in a smaller area, during a heavy task processing the top part of the chip will be very hot, which can cause thermal problems. The scheduler may be programmed to perform optimization analysis employing spatial reasoning to evenly distribute engine allocation onto hardware resources. In other cases, a preset number of engines may be evenly distributed across all space of the hardware.

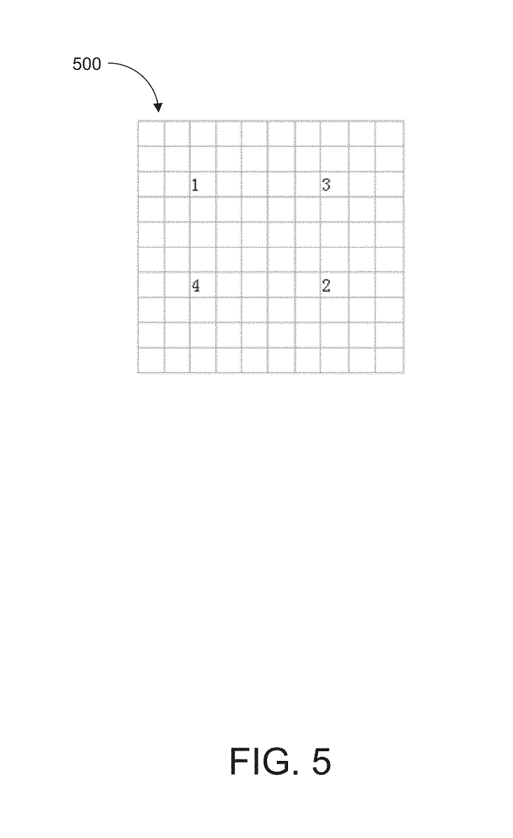

Second, regarding which and/or how many engines are used, the scheduler 301 may be configured to dynamically activate the engines based on the locations of existing activated engines. For example, initially, only one engine is used in the system for starters. A first engine may be activated on the 10×10 die, as shown in illustration 500 of FIG. 5, labeled as “1.” When a second engine is needed, as mentioned above, a balancing location may be one that occurs on the opposite side of center, such as at a position like place “2.” The next engines to be activated may be those labeled “3” and “4,” respectively, based on the same reasoning. In general, the scheduled 301 may be configured to activate a next engine roughly an equal distance away from all other actively existing engines, and continue to operate in this manner, so as to minimize heat imbalance across the hardware die. When one engine has completed its encrypting or decrypting process, in some embodiments the scheduler may be configured to prioritize those locations first, since they would fit the spatial pattern that evenly utilizes the hardware. In other cases, a new configuration may be computed that adjusts for any newly activated engines since the time the finished engine was started. This may result in a slightly different new location for activating an engine.

The following example algorithm, expressed as the function(x) to choose a position for X in number of N² engines, can be as below, but not limited to be the f(X) below:

```
      {
int i = 0;
  int n = N;
    int x = X;
    while((x%4) != x) {
        n = n/4;
        x = x%4;
        i ++;
    }
    switch(n) {
        case 0:
        case 2:
            for(int j = 0; j < 4; j ++) {
              if(arrary[(i+x)*4][j] == 0) {
                arrary[(i+x)*4][j] =1;
                return arrary[(i+x)*4][j] − array;
              }
          }
          return −1;
        case1:
        case3:
            for(int j = 0; j < 9; j ++) {
              if(arrary[(i+x)*4+(j/3)][j%3] == 0) {
                arrary[(i+x)*4+(j/3)][j%3] =1;
                  return arrary[(i+x)*4+(j/3)][j%3] − array;
              }
          }
          return −1;
}
```

Referring again to FIG. 2, after the decryption process (refer to process starting at block 205), decrypted data packets are sent to packet scheduler 107 for further prioritization, at block 207, based on packet information that was not visible before the decryption process. Higher priority decrypted data packets will be put to the front of the queue for further processing by applications 111 in the main data processing unit 102, based on pre-set priority schemes (see blocks 208 and 209). Thus, in some embodiments, two stages of packet prioritization occur when sending the decrypted information to the main processing unit 102. It may be the case that sometimes the second prioritization changes the order from the original first stage prioritization, as the contents of the decrypted information may change the results and are visible only after decryption.

In some embodiments, a data packet processing priority rule can be managed and updated by packet scheduler 107 in hardware processing unit 101.

In some embodiments, packet scheduler 107 may overall prioritize and schedule all data packets for the hardware processing unit 101, which means data packets will not be prioritized by other modules insides hardware processing units 101 before reaching the packet scheduler 107.

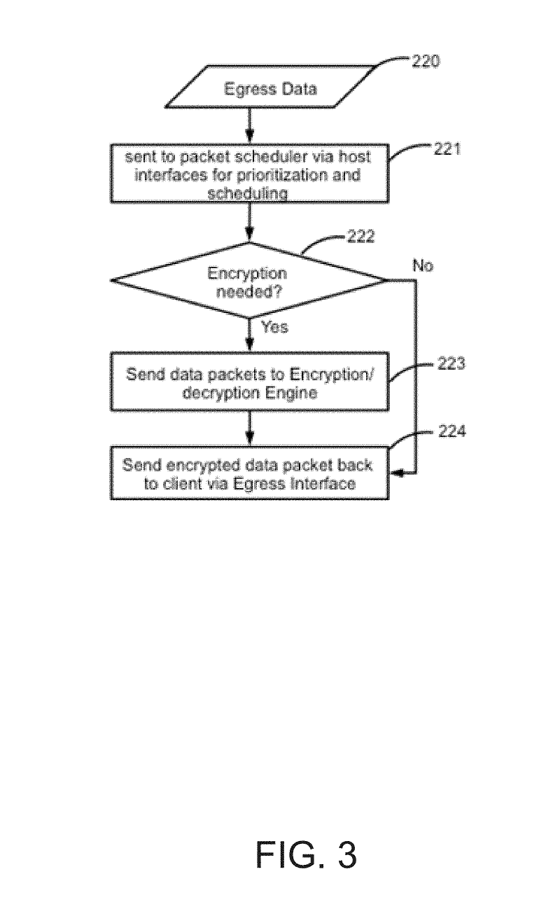

FIG. 3 illustrates an example process of how egress data packets are processed and prioritized in the data processing system illustrated in FIG. 1, according to some embodiments. Starting at block 220, data packets processed by applications 111 in the main processor unit 102 are sent back to packet scheduler 107 inside hardware processing unit 101 via host interface 109 and 108, at block 221. Data packets may be sorted and prioritized by packet scheduler 107. These same schemes may be used to process the ingress data, in some embodiments. Data packets that require encryption will be sent back to encryption/decryption engine 106 to execute encryption, at blocks 222 and 223. The intelligent scheduler 301 within encryption/decryption engine 106 will assign one or multiple encryption/decryption modules/engines from encryption/decryption module pool 302 for the encryption task.

In some embodiments, the key for encryption will be generated and provided by security engine 110 and delivered to encryption/decryption engine 106 via host interface 109 and 108. During the encryption process, the key is managed within the main processing units 102 and hardware processing unit 101 without being sent to outside of data processing system 100.

In some embodiments, the prioritization of which data packets may be encrypted is similar to the prioritization processes for decryption, except occurring in reverse. For example, the hardware processing unit 101 may analyze the data packets to determine a prioritization of which packets should be encrypted ahead of or behind others. The prioritization may be based on a set of pre-determined priority rules, according to some embodiments. Depending on how the content of the data is classified, the data packets may then be placed in a queue for encryption according to a prioritization.

Encrypted packages will be sent to egress interface 104 after encryption. Data packets that do not require encryption will queue together with the encrypted data packets at egress interface 104 and be sent back to client, at block 224, from block 222.

The present disclosure is illustrative and not limiting. Further modifications will be apparent to one skilled in the art in light of this disclosure and are intended to fall within the scope of the appended claims.

What is claimed is:

1. A system comprising:
a main processing unit for processing data in incoming data packets; and
a programmable, hardware parallel-processing unit in communication with the main processing unit via a host communication interface, wherein the programmable, hardware parallel-processing unit is configured to:
receive the incoming data packets, wherein the incoming data packets are encrypted;
analyze a packet header for each of the incoming data packets;
prioritize the incoming data packets based on information in the analyzed packet header for each incoming data packet;
place the received, incoming data packets in a decryption queue for decryption based on the prioritization;
decrypt the received, incoming data packets in the order of placement in the queue for decryption; and
place the decrypted data packets in a data queue for processing by the main processing unit, based on the prioritization, wherein:
higher priority decrypted data packets are put in a front of the data queue and lower priority decrypted data packets are put in back of the data queue; and
the main processing unit retrieves and processes the decrypted data packets from the data queue, wherein the main processing unit processes the decrypted data packets from the front of the data queue before processing the decrypted data packets from the back of the data queue.

2. The system of claim 1, wherein the prioritization of the decrypted data packets is based on pre-set priority rules.

3. The system of claim 1, wherein the main processing unit comprises a central processing unit, and the programmable, hardware parallel-processing unit comprises at least one of a field programmable gate array (FPGA), digital signal processor (DSP), and a graphical processor unit (GPU).

4. The system of claim 1, wherein the main processing unit further comprises a security engine configured to provide decryption keys to the programmable, hardware parallel-processing unit for decrypting the incoming data packets.

5. The system of claim 1, wherein the programmable, hardware parallel-processing unit comprises a packet scheduler, an encryption/decryption engine, and a data packet filter.

6. The system of claim 1, wherein the programmable, hardware parallel-processing unit comprises a plurality of encryption/decryption engines spaced evenly across a hardware die such that the hardware die heats evenly across its entirety after the plurality of encryption/decryption engines are activated.

7. The system of claim 6, wherein the programmable, hardware parallel-processing unit comprises an encryption/decryption scheduler configured to activate each of the plurality of encryption/decryption engines only as needed to perform encryption/decryption of the incoming data packets.

8. The system of claim 7, wherein the encryption/decryption scheduler is further configured to select which of the encryption/decryption engines is to be activated based on locations of existing activated encryption/decryption engines, such that a next activated encryption/decryption engine is activated in a location that minimizes an imbalance of heat generation across the hardware die.

9. The system of claim 1, wherein the programmable, hardware parallel-processing unit is further configured to:
analyze the decrypted data packets; and
re-prioritize the data packets based on the analyzed decrypted data packets;
wherein the placing of the decrypted data packets in the data queue for processing by the main processing unit is based on the re-prioritization.

10. The system of claim 5, wherein the data packet filter is configured to de-prioritize or drop an incoming data packet after determining that the incoming data packet originates from a suspicious source.

11. The system of claim 1, wherein the programmable, hardware parallel-processing unit is further configured to decrypt data packets in parallel.

12. A method of a programmable, hardware parallel-processing unit for encrypting and decrypting data packets, the hardware parallel-processing unit in communication with a main processing unit via a host communication interface, the method comprising:
receiving incoming data packets, wherein the incoming data packets are encrypted;
analyzing a packet header for each of the incoming data packets;
prioritizing the incoming data packets based on information in the analyzed packet header for each incoming data packet;
placing the received, incoming data packets in a decryption queue for decryption based on the prioritization;
decrypting the received, incoming data packets in the order of placement in the queue for decryption; and
placing the decrypted data packets in a data queue for processing by the main processing unit, based on the prioritization, wherein:
higher priority decrypted data packets are put in a front of the data queue and lower priority decrypted data packets are put in back of the data queue; and
the main processing unit retrieves and processes the decrypted data packets from the data queue, wherein the main processing unit processes the decrypted data packets from the front of the data queue before processing the decrypted data packets from the back of the data queue.

13. The method of claim 12, wherein the main processing unit comprises a central processing unit, and the programmable, hardware parallel-processing unit comprises at least one of a field programmable gate array (FPGA), digital signal processor (DSP), and a graphical processor unit (GPU).

14. The method of claim 12, wherein the main processing unit further comprises a security engine configured to provide decryption keys to the programmable, hardware parallel-processing unit for decrypting the incoming data packets.

15. The method of claim 14, wherein the programmable, hardware parallel-processing unit comprises a packet scheduler, an encryption/decryption engine, and a data packet filter.

16. The method of claim 12, wherein the programmable, hardware parallel-processing unit comprises a plurality of encryption/decryption engines spaced evenly across a hardware die such that the hardware die heats evenly across its entirety after the plurality of encryption/decryption engines are activated.

17. The method of claim 15, wherein the programmable, hardware parallel-processing unit comprises an encryption/decryption scheduler configured to activate each of the plurality of encryption/decryption engines only as needed to perform encryption/decryption of the incoming data packets.

18. The method of claim 17, further comprising selecting which of the encryption/decryption engines is to be activated based on locations of existing activated encryption/decryption engines, such that a next activated encryption/decryption engine is activated in a location that minimizes an imbalance of heat generation across the hardware die.

19. The method of claim 1, further comprising:
analyzing the decrypted data packets; and
re-prioritizing the data packets based on the analyzed decrypted data packets;
wherein the placing of the decrypted data packets in the data queue for processing by the main processing unit is based on the re-prioritization.

20. A system comprising:
a main processing unit for processing data in outgoing data packets; and
a programmable, hardware parallel-processing unit in communication with the main processing unit via a host communication interface, wherein the programmable, hardware parallel-processing unit is configured to:
receive the outgoing data packets from the main processing unit, wherein the outgoing data packets are decrypted;
analyze the outgoing data packets;
prioritize the outgoing data packets based on information in the outgoing data packets;
place the received, outgoing data packets in an encryption queue for encryption based on the prioritization;
encrypt the received, outgoing data packets in the order of placement in the queue for encryption; and
transmit the encrypted data packets according to the order encrypted through an egress interface, wherein:
higher priority outgoing data packets are put in a front of the data queue and lower priority outgoing data packets are put in back of the data queue; and
the programmable, hardware parallel-processing unit retrieves and processes the decrypted data packets from the data queue, wherein the programmable, hardware parallel-processing unit encrypts the decrypted data packets from the front of the data queue before encrypting the decrypted data packets from the back of the data queue.
